(19) United States
(12) Patent Application Publication
(10) Pub. No.: US 2005/0086093 A1
(43) Pub. Date: Apr. 21, 2005

(54) Asset management systems

(75) Inventors: Safe E' Dean Hammad, London (GB); James Jeffrey Duckenfield, London (GB)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Newfield Information Technology Limited

(21) Appl. No.: 10/883,894

(22) Filed: Jul. 2, 2004

(30) Foreign Application Priority Data
Oct. 16, 2003 (GB) 0324275.7

(51) Int. Cl. G06F 17/60

(52) U.S. Cl. 705/8; 705/1

(57) ABSTRACT

The present invention provides systems and apparatus for use in asset management. The invention displays an image of a floor plan to a user. Further, the invention allows the user to select from a plurality of indicators, where each indicator represents a respective asset. Following selection, the invention allows the user to position the indicators on the image of the floor plan in respective positions reflecting the physical location of the respective assets. The invention allows the user to group assets, create group layers, store information about each, as well as other asset management features.

### BACKGROUND OF THE INVENTION

1. Field of the Invention

This invention relates to asset management systems and in particular asset management apparatus.

2. Description of Related Art

The general field of asset management concerns the accurate logging and maintaining of a record of the business assets which a business has. Thus, in this context “asset” is used to mean such things as IT hardware including computers, printers, scanners etc., office furniture, lighting, and other such infrastructure.

Accurate recording and keeping of up-to-date records regarding such assets is a major task and it is therefore desirable to provide apparatus which ease this task.

### BRIEF SUMMARY OF THE INVENTION

It is an object of the present invention to provide apparatus and systems which can aid in the asset management process.

According to one aspect of the present invention there is provided asset management apparatus arranged under the control of software to:
display an image of a floor plan;
allow the selection, by a user, of a plurality of indicators, each indicator indicating a respective asset;
display on the image of the floor plan the plurality of indicators; and
allow each indicator to be positioned by a user on the image of the floor plan in a respective position reflecting the physical location of the respective asset.

The apparatus may comprise a general purpose computer, in particular a tablet PC.

The apparatus may be arranged to allow selective display of indicators from within said plurality of indicators on the image of the floor plan.

The apparatus may be arranged to allow selection of, and to display, indicators representing a plurality of types of asset.

The apparatus may be arranged so that where a plurality of indicators representing a common type of asset are selected, these indicators are associated with one another as a group, so that the display of the plurality of indicators, on the image of the floor plan, is controllable as a group.

Preferably the apparatus is arranged so that where a plurality of indicators are selected such that within said plurality there can be defined a plurality of sets of indicators with each indicator within a respective set representing a respective type of asset, the indicators within each set are associated with one another as a respective group, so that the display of indicators within each set, on the image of floor plan, is controllable as a group.

The association of indicators representing particular types of asset into groups for selective display allows different types of asset to be displayed on the floor plan individually, all at the same time, or in selected combinations. As a specific example, one type of asset might be printers, another might be PCs and a further type might be lighting. In this case, the apparatus could be used to show all of these assets together, but there might also be interest in showing just IT assets (ie printers and PCs) or just a single asset (eg PCs). The present apparatus allows this.

The apparatus may be arranged to provide a filter function useable by a user to select groups of indicators for display.

The indicators in different groups may be considered to be applied to the image of the floor plan in layers.

Preferably the apparatus is arranged to allow the selection and positioning of a plurality of indicators on the image of the floor plan in an order chosen by the user, irrespective of whether the indicators all represent a common type of asset or a plurality of different types of asset.

Preferably the apparatus is arranged to associate appropriately into said groups, a plurality of indicators selected and positioned on the image of the floor plan, regardless of the order in which the indicators within said plurality are selected and positioned.

The apparatus may comprise a data storage means for storing information in association with each indicator. The apparatus may comprise a database for storing information in association with each indicator.

The data stored in association with each indicator will typically comprise at least an indication of the type of asset to which the indicator relates and information concerning the position of the asset as input by the action of a user positioning the indicator on the image of the floor plan.

The apparatus may be arranged to allow user input of information in association with each indicator selected and positioned on the image of the floor plan. User input information may for example comprise details of the asset to which the indicator relates, these details might include a make, a model, a serial number etc.

Data relating to indicators for display on the floor plan may be stored in the data storage means in groups which reflect the type of asset which the indicators represent.

The data storage means may be arranged to store a plurality of floor plans and associated indicators.

The apparatus may be arranged to present to a user a predetermined collection of indicators for selection. Each indicator in the collection may represent a predetermined type of asset. The apparatus may be arranged to allow a user to add user defined indicators. The apparatus may be arranged to allow a user to configure at least one of the predetermined collection of indicators so as to represent a user defined type of asset.

Indicators representing a first type of asset may be visually distinguishable from indicators representing a second type of asset.

Each indicator may comprise an icon.

The apparatus may be used as a business asset data capture tool. The data captured using the apparatus may be exported for storage and/or analysis.

According to another aspect of the present invention there is provided a method of operating a computer to provide asset management apparatus, the method comprising the steps of:
displaying an image of a floor plan;
allowing the selection, by a user, of a plurality of indicators, each indicator indicating a respective asset;
displaying on the image of the floor plan the plurality of indicators; and
allowing each indicator to be positioned by a user on the image of the floor plan in a respective position reflecting the physical location of the respective asset.

According to another aspect of the present invention there is provided a method of business asset data capture comprising the steps of:
displaying an image of a floor plan;
allowing the selection, by a user, of a plurality of indicators, each indicator indicating a respective asset;
displaying on the image of the floor plan the plurality of indicators; and
allowing each indicator to be positioned by a user on the image of the floor plan in a respective position reflecting the physical location of the respective asset.

According to another aspect of the present invention there is provided a computer program comprising code portions which when loaded and run on a computer, cause the computer to operate as an asset management apparatus as defined above.

According to another aspect of the present invention there is provided a computer readable data carrier carrying a program as defined above.

Embodiments of the present invention will now be described, by way of example only, with reference to the accompanying drawings in which:

FIG. 1 schematically shows asset management apparatus;

FIGS. 2A to 2D show screen displays of the asset management apparatus;

FIG. 3 schematically shows elements of the software controlling the asset management apparatus;

FIG. 4 is a flow chart illustrating the process of adding an icon indicative of a particular asset on the display screen of the apparatus of FIG. 1; and

FIG. 5 shows the process of building an image for display on the display screen of the apparatus of FIG. 1.

### BRIEF DESCRIPTION OF THE SEVERAL VIEWS OF THE DRAWING(S)

FIG. 1 schematically shows an asset management apparatus embodying the present invention.

A detailed description of the apparatus will be given below, but first a brief outline is given to aid in understanding.

At a general level the present apparatus can be considered to comprise a computer arranged under the control of software to facilitate the efficient capture and storage of business asset data. Using the computer as arranged under control of the software, details of buildings and floors, and in particular floor plans, are entered into the computer and a digital image of a floor plan may be associated with each floor. The apparatus then allows a user to position icons onto the floor plans with each icon representing a given type of asset for example, a printer, scanner, copier etc. Data may then be associated with each icon, for example the make and model of the printer. The type, position and associated data of each icon is then saved to disk for later analysis. In this manner a virtual view of assets within a floor, a building or a whole organization may be built.

### DETAILED DESCRIPTION OF THE INVENTION

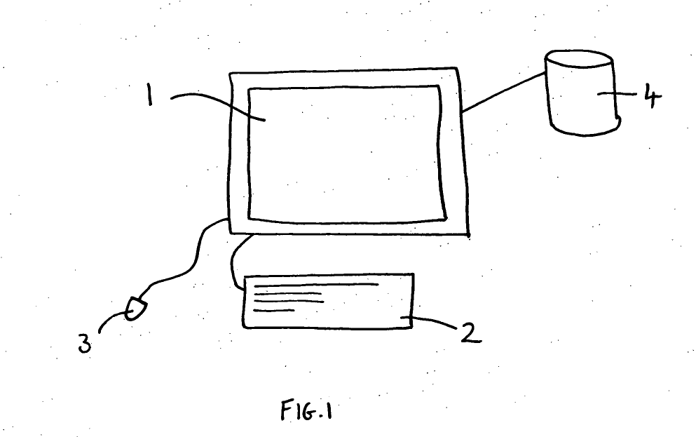

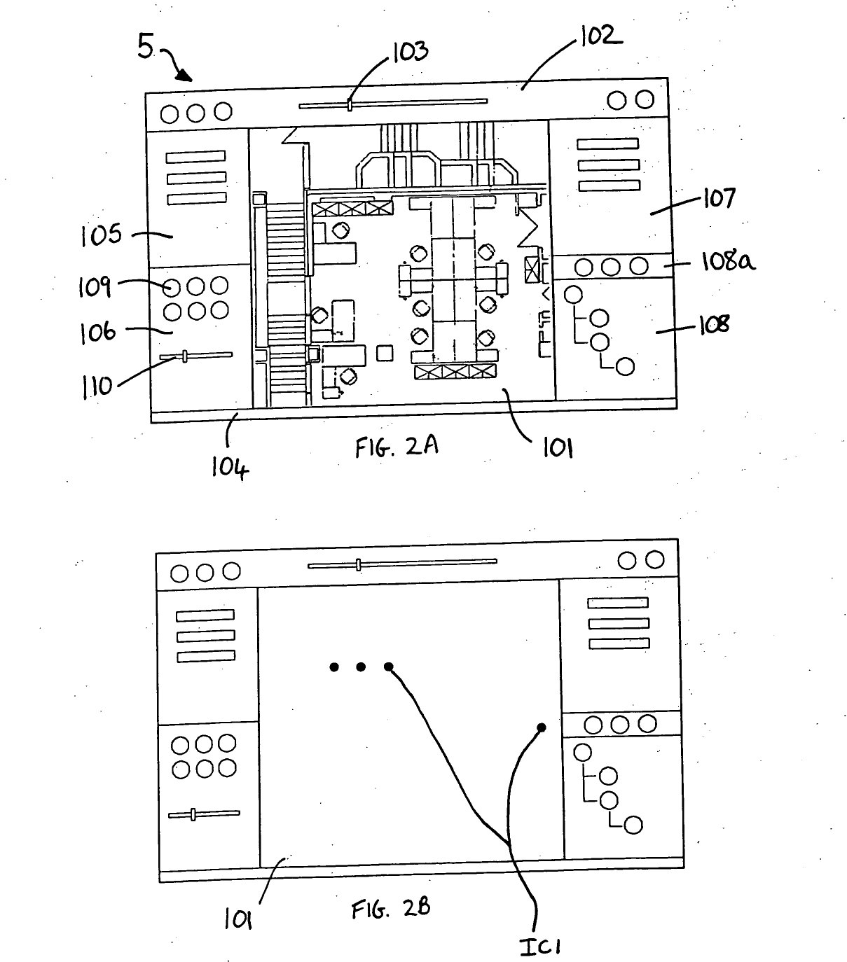

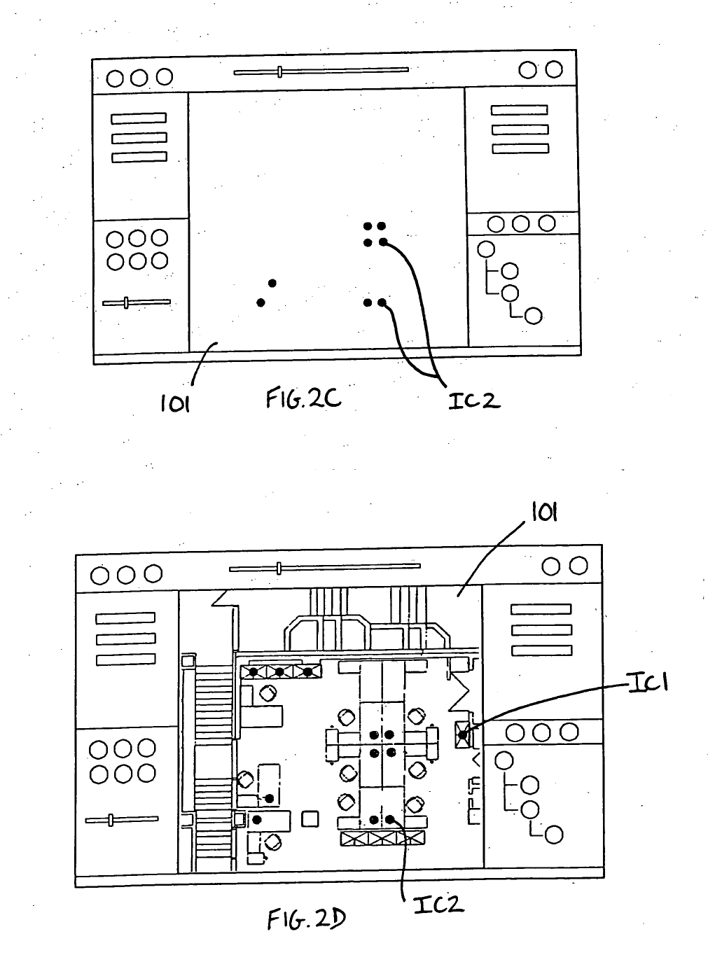

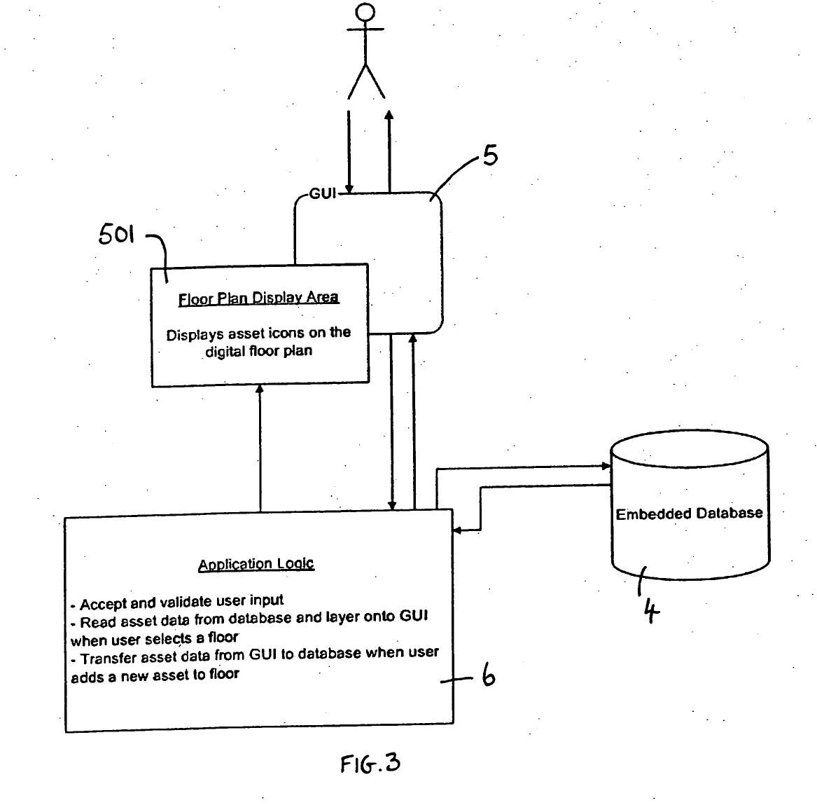

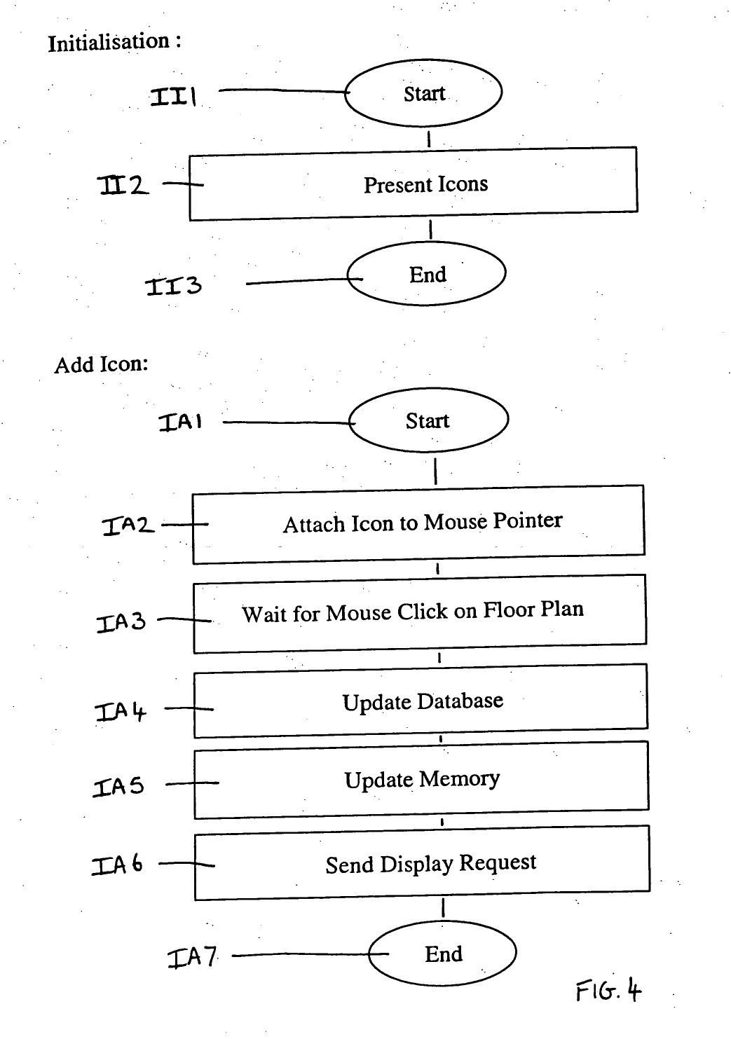

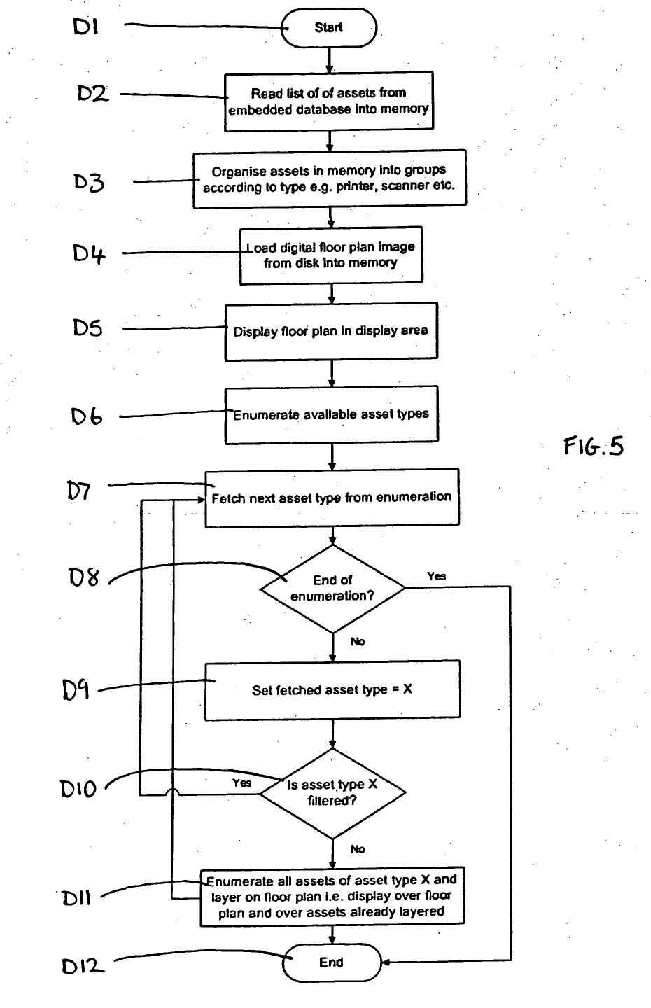

The apparatus comprises a general purpose PC comprising all the normal elements of a PC, for example a processor, a hard disk, random access memory and so on. As these components are conventional and are used in the conventional way in the present apparatus further description of these is omitted and these elements are not specifically shown in FIG. 1.

As shown in FIG. 1 the apparatus comprises a display screen 1, a keyboard 2 and mouse 3 and again each of these components is generally conventional and may be used in the conventional way. The apparatus further comprises a database 4 which is resident on the hard drive of the PC and the purpose of which will be described in more detail below.

In the present case the software used to control the computer is important in determining the characteristics of the apparatus as a whole. More detail of the software will be described below but to aid in understanding an overview of the functioning of the apparatus is given below with reference to FIGS. 2A to 2D.

FIG. 2A shows the basic graphical user interface (GUI) 5 which is displayed, under the control of the software, on the display screen 1 of the apparatus. The graphical user interface 5 comprises seven main sections.

The central window 101 is a floor plan display area and in FIGS. 2A and 2D; a floor plan is shown in this area. At the top of the GUI 5 is a main toolbar 102 which includes various controls for use in controlling the overall operation of the apparatus, and in particular includes a zoom bar 103 for zooming the floor plan displayed in the display window 101 in and out. Although not shown in the figures, scroll bars are provided on appropriate edges of the floor plan display area 101 to allow scrolling around the floor plan.

At the bottom of the GUI 5 is a status bar 104 which is used to provide feedback to the user.

On the left hand edge of the GUI 5 are two panes 105 and 106 which both relate to assets and the respective icons which may be added to the floor plan.

On the right hand edge of the GUI 5 are two panes 107 and 108 which relate to the floor plan which is displayed in the floor plan display area 101.

Whereas FIG. 2A shows a blank floor plan in the display area 101, FIG. 2D shows a floor plan to which indicators or icons IC1, IC2 have been added. These icons IC1, IC2 indicate the presence of assets at locations on the floor plan which reflect their physical location in the building to which the floor plan relates.

The two panes 107, 108 on the right hand edge of the GUI may be used to manage the floor plans stored by the apparatus and displayed in the floor plan display window 101.

The lower right pane 108 shows a hierarchical tree of floor plans which have been built up and stored in the apparatus database 4. Typically the highest level of this hierarchy will be an organization, the next level down will be a particular site or building and the next level down will be floors or areas within that site which have associated floor plans stored in the database 4. It should be noted however, that the number of layers created and significance thereof is definable by the user.

Generally speaking paper floor plans will be scanned into the apparatus for storage in the database 4 although it is quite possible for digital plans to be stored directly in the database 4.

An upper portion 108a of the lower pane 108 includes a number of functional buttons which can be used in the management of the floor plan stored in the database 4.

A particular organization, building, or floor plan etc., may be selected by clicking upon the appropriate icon in the hierarchical tree included in pane 108. When this is done, details associated with that selected organization, building, floor plan etc., may be entered via the upper right hand pane 107. Any such data will be stored in the database 4 in association with the respective item.

The lower left hand pane 106 is used by the user in the process of adding icons to a floor plan displayed in the display area 101.

As shown in FIGS. 2A to 2D there are six icon selection buttons 109 included in the lower left pane 106 and an icon size control bar 110. Each of the icon selection buttons 109 is associated with a specific type of asset which can be added to the floor plan. Thus, for example, one of the buttons 109 might relate to printers, another might relate to scanners, another to PC's and so on. Further, whilst only six icon selection buttons 109 are shown in FIGS. 2A to 2D a larger number may be made available to the user. These may be arranged on different tabs which the user can select.

In the process of adding an asset to the floor plan, displayed in the display window 101, the user first clicks on the appropriate icon button 109 (using the mouse 3) and then clicks on the desired position on the floor plan in the display area 101 to position the icon representing the asset appropriately. This icon may then be locked in position using a functional button provided in the main tool bar 102. Whilst the icon selected and positioned in the floor plan 101 gives an indication of the type of asset, more specific details about that asset may be entered via the upper left pane 105 in the GUI 5 (using the mouse 3 and keyboard 2 as appropriate) and these details will then be stored in the database 4 in association with that particular icon as located on the floor plan. That is to say, each and every icon which is located on the floor plan can also have additional information associated therewith and this information can be input via (and viewed in) the upper left pane 105 when the respective icon is selected on the floor plan.

It should also be noted that it is possible for a user to configure each of the icon selection buttons 109 so that a desired icon is shown and this icon is associated with a selected type of asset. That is to say whilst the software may be supplied to a user with a given base set of icons and associated assets, it is quite possible for the user to add new icons as necessary and/or modify the type of asset to which each icon is related.

Further, whilst not shown in the drawings, the bottom left pane 106 also provides access to a range of functions in respect of assets which have been added to a floor plan by means of respective icons. A statistics function is provided where an indication of the quantity of each type of asset added to a given floor plan is displayed to a user. A search functionality is provided which will search for assets of a certain type entered by the user. A relocate function is provided to assist in moving an asset from one floor to another. Perhaps most importantly, a filter function is provided to allow a user to view assets of a particular type or a particular combination of types. Thus, using the filter function, the user may choose to display on the floor plan selected types of assets from amongst those that have been stored in the database 4. As an example, if icons representing printers, PC's and network ports have been added to a plan, the user may choose to show, for example, only printers, only PC's or network ports and PC's.

Icons may be added by the user using the buttons 109 to the floor plan shown in the display area 101 at any time and in any order chosen by the user. That is to say it is quite possible for the user to walk around a building adding assets to the corresponding floor plan as these are come across. As an example, the user may first add two printers then a PC then a further printer then three further PC's and then a scanner and so on. In each case respective icons will be selected using the appropriate icon selection button 109 and then positioned on the appropriate floor plan. At any point during this data gathering process (or at the end of the process) the different types of assets logged may be shown together, separately (i.e. a single type of asset being shown) or in any desired combination.

FIGS. 2A to 2D schematically show the process followed by the apparatus when building up an image of a floor plan to which icons IC1, IC2 representing different types of asset have been added. As a first step, the floor plan itself is loaded into memory as illustrated by FIG. 2A. Then, as illustrated in FIG. 2B, icons IC1 relating to a first type of asset are retrieved from the database and loaded into memory. Then, as illustrated in FIG. 2C, the icons IC2 relating to a second type of asset are retrieved from the database and loaded into memory. Finally the complete display consisting of these three layers is presented to the user as shown in FIG. 2D.

Of course, where there are further different types of asset, and corresponding icons have been added to the floor plan, there will be further respective intermediate steps where the details of the respective icons are extracted from the database into memory.

FIG. 3 schematically shows the main elements of the software used to drive the apparatus. These elements comprise the graphical user interface 5, including as an important part, the floor plan display area 501, the database 4 in which the information concerning floor plans and assets are stored and an application logic module 6 which enables interaction between the graphical user interface 5 (and hence the user) and the database 4.

The application logic module 6 amongst other functions:
1) accepts and validates user input;
2) reads asset data from the database 4 and layers this onto the graphical user interface 5 when the user selects a floor plan for display; and
3) transfers asset data from the graphical user interface 5 to the database 4 when the user adds a new asset (i.e. icon) to a floor plan.

FIG. 4 shows a flow chart of the procedure followed when a user initiates the process of adding an icon to the floor plan. First an initialisation process starts at step II1 and this causes the apparatus to present the available icons in the graphical user interface 5 to the user for selection in step II2. At this point the initialisation process ends in step II3.

An add icon process starts in step IA1 when a user clicks on one of the presented icon selection buttons 109. At this point in step IA2, the respective icon is attached to the mouse pointer. In step IA3, the apparatus waits for a mouse click on the floor plan. Once such a click is detected the database 4 is updated with details of the new asset which has been added to the floor plan including the type of asset and its position. In step IA5 the memory of the apparatus is updated with the same asset and in step IA6 this procedure sends a display request to update the display. The display update process is described separately below in relation to FIG. 5. Once the display request is sent, the add icon process ends in step IA7.

FIG. 5 schematically shows the series of steps through which the apparatus proceeds in displaying a floor plan together with associated icons representing recorded assets.

The process is started in step D1 as the result of a display request and in step D2 the apparatus, and more specifically the application logic module 6, reads the list of assets from the embedded database 4 in respect of the appropriate floor plan into memory. In step D3 the apparatus organizes the assets in memory into groups according to asset type.

In step 4 the digital floor plan image is loaded from disk into memory and in step D5 the floor plan is displayed in the display area 101.

In step D6 the available asset types are identified and counted. In step D7 the next asset type from the result of step D6 is fetched. Thus, in the first occurrence of step D7 the first asset type will be fetched.

In step D8 a determination is made as to whether all of the available asset types have been considered and if the answer to this determination is “yes” then the process proceeds to step D12 where it ends.

Alternatively, if the outcome of this determination is “no” such that not all of the asset types have been considered then in step D9 a variable “fetched asset type” is set to the appropriate value and in step D10 the determination is made as to whether the respective asset type is “filtered”. This determination is in effect a determination of whether this asset type is prevented from display by a filtering option chosen by a user.

If the determination in step D10 is that this asset type is prevented from display then the process returns to step D7 for consideration of the next asset type.

Alternatively, if the determination is made that this asset type is not prevented from display then in step D11 all assets of the appropriate asset type are layered onto the floor plan. That is to say icons representing this asset type are displayed on the floor plan in addition to any other asset icons which have already been added. After the process in step D11 is complete there is a return to step D7 where the next asset type is considered. Steps D7 to D11 are carried out in respect of each asset type identified in step D6. Once each of these types has been processed the process ends in step D12.

Whilst the above description mentions the use of a mouse 3 as a pointing device and a keyboard 2 for entering user data, it will of course be appreciated that different input devices may be used. For example, a stylus or pen and a touch sensitive screen might be used as a pointing device and/or for entering data.

It will be appreciated that there is little or no limit on the type of business assets which may be represented on a floor plan using the present apparatus. Therefore, whilst the particular examples given above have mainly related to IT assets the apparatus is equally suited to the logging of other business assets such as office furniture, network cabling and ports, power cabling and outlets and so on.

A computer program comprising code portions such as to cause a computer system to operate as an apparatus described above can embody the present invention. Of course, such a computer program may be carried on any suitable data carrier which may, for example, be a signal or a type of physical storage media such as a hard disc, a floppy disk, a DVD ROM, a CD ROM etc.

It will be clear that the above apparatus and computer program may be used in a method of asset management and/or asset data capture. It should also be noted that the resulting information captured using the present apparatus may be exported for storage and/or analysis elsewhere. That is to say, the database 4 built up as a product of using the present apparatus may be exported and used on a different apparatus either of the same general type as that described above or of a different type. It will be noted that whilst the data stored in the database 4 may be advantageously displayed using the apparatus of the present embodiment such that icons appear on floor plans in locations which are indicative of the physical location of the respective assets, this visual indication and location information may not be essential. Thus even if the precise physical location data concerning assets cannot be displayed on another apparatus, the raw data concerning the number of assets, the different types of assets and the more detailed user entered information stored in respect of each of these assets can still be useful.

Thus it will be seen that the present apparatus is arranged to assist in the asset management process and, in particular, provides a mechanism for business assets to be recorded into a database in a convenient and user friendly way. In particular, this is facilitated by the provision of a floor plan to which icons representing assets may be added. Further, review of the entered data is made easier by virtue of the apparatus being provided with the means to selectively display different types of asset on the floor plan independently of one another or in chosen combinations as selected by the user.

It is important to note that in the present application the floor plans displayed are just that, ie floor plans rather than some logical version of a floor plan. That is to say the floor plan properly represents the phyiscal location of elements on the floor so that an added icon can properly represent the physical location of the asset which it represents.

It is envisaged the current type of device which may most usefully be used as the basis of an apparatus embodying the present invention is a tablet PC.

1. Asset management apparatus arranged under the control of software to:
display an image of a floor plan;
allow the selection, by a user, of a plurality of indicators, each indicator indicating a respective asset;
display on the image of the floor plan the plurality of indicators; and
allow each indicator to be positioned by a user on the image of the floor plan in a respective position reflecting the physical location of the respective asset.

2. Asset management apparatus according to claim 1 which is arranged to allow selective display of indicators from within said plurality of indicators on the image of the floor plan.

3. Asset management apparatus according to claim 1 which is arranged to allow selection of, and to display, indicators representing a plurality of types of asset.

4. Asset management apparatus according to claim 1 which is arranged so that where a plurality of indicators representing a common type of asset are selected, these indicators are associated with one another as a group, so that the display of the plurality of indicators, on the image of the floor plan, is controllable as a group.

5. Asset management apparatus according to claim 1 which is arranged so that where a plurality of indicators are selected such that within said plurality there can be defined a plurality of sets of indicators with each indicator within a respective set representing a respective type of asset, the indicators within each set are associated with one another as a respective group, so that the display of indicators within each set, on the image of floor plan, is controllable as a group.

6. Asset management apparatus according to claim 4 which is arranged to provide a filter function useable by a user to select groups of indicators for display.

7. Asset management apparatus according to claim 4 in which the indicators in different groups can be considered to be applied to the image of the floor plan in layers.

8. Asset management apparatus according to claim 1 in which the apparatus is arranged to allow the selection and positioning of a plurality of indicators on the image of the floor plan in an order chosen by the user, irrespective of whether the indicators all represent a common type of asset or a plurality of different types of asset.

9. Asset management apparatus according to claim 8 in which the apparatus is arranged to associate appropriately into groups, a plurality of indicators selected and positioned on the image of the floor plan, regardless of the order in which the indicators within said plurality are selected and positioned.

10. Asset management apparatus according to claim 1 comprising a data storage means for storing information in association with each indicator.

11. Asset management apparatus according to claim 10 which is arranged to allow user input of information in association with each indicator selected and positioned on the image of the floor plan.

12. Asset management apparatus according to claim 10 in which the data storage means is arranged to store a plurality of floor plans and associated indicators.

13. Asset management apparatus according to claim 1 which is arranged to present to a user, a predetermined collection of indicators for selection.

14. Asset management apparatus according to claim 1 which is arranged to allow a user to add user defined indicators.

15. Asset management apparatus according to claim 13 which is arranged to allow a user to configure at least one of the predetermined collection of indicators so as to represent a user defined type of asset.

16. Asset management apparatus according to claim 1 in which indicators representing a first type of asset are visually distinguishable from indicators representing a second type of asset.

17. Asset management apparatus according to claim 1 comprising a general purpose computer, in particular a tablet PC.

18. Asset management apparatus according to claim 1 which is arranged for use as a business asset data capture tool, the data captured using the apparatus being exportable for storage and/or analysis.

19. A computer readable data carrier carrying a computer program comprising code portions which when loaded and run on a computer, cause the computer to operate as an asset management apparatus to:
display an image of a floor plan;
allow the selection, by a user, of a plurality of indicators, each indicator indicating a respective asset;
display on the image of the floor plan the plurality of indicators; and
allow each indicator to be positioned by a user on the image of the floor plan in a respective position reflecting the physical location of the respective asset.

20. A method of operating a computer to provide asset management apparatus, the method comprising the steps of:
displaying an image of a floor plan;
allowing the selection, by a user, of a plurality of indicators, each indicator indicating a respective asset;
displaying on the image of the floor plan the plurality of indicators; and
allowing each indicator to be positioned by a user on the image of the floor plan in a respective position reflecting the physical location of the respective asset.

21. A method of business asset data capture comprising the steps of: displaying an image of a floor plan;
allowing the selection, by a user, of a plurality of indicators, each indicator indicating a respective asset;
displaying on the image of the floor plan the plurality of indicators; and
allowing each indicator to be positioned by a user on the image of the floor plan in a respective position reflecting the physical location of the respective asset.
